(19) United States
(12) Patent Application Publication
(10) Pub. No.: US 2003/0219187 A1
(43) Pub. Date: Nov. 27, 2003

(54) Ladder electrode optical modulator and method of manufacture thereof

(75) Inventor: Shinichi Shimotsu, Emmaus, PA (US)

Correspondence Address: HITT GAINES P.C., P.O. BOX 832570, RICHARDSON, TX, 75083, US

(73) Assignee: Agere Systems Inc., Allentown, PA (US)

(21) Appl. No.: 10/152,510

(22) Filed: May 21, 2002

(51) Int. Cl. G02F 1/035

(52) U.S. Cl. 385/1; 385/40

(57) ABSTRACT

The present invention provides an optical modulator, a method of manufacture thereof and an optical transmitter employing the optical modulator. In one embodiment, the optical modulator includes a substrate having a waveguide located therein, and an electrode, located adjacent the waveguide, having at least one aperture located therein.

### TECHNICAL FIELD OF THE INVENTION

The present invention is directed, in general, to an optical communications system and, more specifically, to an optical modulator and a method of manufacture thereof.

### BACKGROUND OF THE INVENTION

Optical communications systems are becoming increasingly important in the data communications arena as the demand for broadband systems increases. Certain types of waveguide-based optical switches, also referred to as optical modulators, are commonly used in optical communications systems. For example, high-speed optical modulators are used to encode information into an optical signal generated by an optical source, such as an optical laser. The modulating information may typically be represented by changes in an amplitude of the optical signal. In this case, an optical modulator is a device that varies an amplitude of an optical signal passing through it.

Typically, such modulation is achieved by applying a modulating signal drive voltage or current, through electrodes associated with the modulator, to generate an electrical field that influences the optical signal being modulated. It is generally desirable to provide optical modulators that achieve both an efficient modulating signal throughput capability and allow appropriate modulation of the optical signal at a low drive voltage or current. However, achieving both of these goals has been problematic.

An efficient modulating capability throughput requires that the modulation signal path maintain a substantially constant characteristic impedance to avoid reflected modulating signal energy, which causes distortion of the modulating signal. This requirement typically places constraints on a conventional modulating signal electrode structure wherein a higher modulating signal drive voltage or current may be required to achieve an appropriate modulation effectiveness for the optical modulator. Referring to FIGS. 1A and 1B, a conventional optical modulator is illustrated that may be used to demonstrate this condition.

FIGS. 1A and 1B illustrate respective top and cross sectional views of the conventional optical modulator, generally designated 100. The conventional optical modulator 100 employs an optical substrate 105 having an optical waveguide 110 that uses a pair of optical conductors 110A, 110B to accommodate a modulating signal. The optical conductors 110A, 110B need to maintain a minimum separation distance (currently about 30 micrometers) to avoid having their signals interfere with one another. Of course, larger separation distances are generally desirable and may be required in some cases.

The conventional optical modulator 100 also has a three element electrode structure 115, 120, 125 that accommodates a differential modulation signal. The differential signal, having equal and opposite polarities, may be applied to outside electrodes 120, 125 while the center electrode 115 is used as the signal common. It may be seen in FIG. 1 that the width of the center electrode 115 is significantly less than the distance between the pair of optical conductors 110A, 110B. This width and the size of electrode gaps 116, 117 are typically determined by the desired value of characteristic impedance.

In this example, the electrode structure 115, 120, 125 produces a modulation energy field that does not efficiently couple to the optical conductors 110A, 110B due to its alignment mismatch with respect to the separation of optical conductors 110A, 110B. This alignment mismatch requires that the modulation signal voltage or current generally be much greater than for a proper alignment situation to provide an effective modulation of the optical signal. However, higher modulating signal voltages or currents typically cause undesirable interference, operational or even breakdown situations.

Accordingly, what is needed in the art is an optical modulator that allows a lower modulating signal voltage or current to provide effective coupling to an optical waveguide while maintaining a characteristic impedance associated with the modulating signal path.

### SUMMARY OF THE INVENTION

To address the above-discussed deficiencies of the prior art, the present invention provides an optical modulator, a method of manufacture thereof and an optical transmitter employing the optical modulator. In one embodiment, the optical modulator includes a substrate having a waveguide located therein, and an electrode, located adjacent the waveguide, having at least one aperture located therein.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

The invention is best understood from the following detailed description when read with the accompanying FIGUREs. It is emphasized that in accordance with the standard practice in the optoelectronic industry, various features may not be drawn to scale. In fact, the dimensions of the various features may be arbitrarily increased or reduced for clarity of discussion. Reference is now made to the following descriptions taken in conjunction with the accompanying drawings, in which:

FIGS. 1A and 1B illustrate a top view and a cross sectional view of a prior art, conventional optical modulator;

FIGS. 2A, 2B and 2C illustrate a top view and two cross sectional views of an embodiment of an optical modulator constructed in accordance with the principles of the present invention;

FIGS. 3A, 3B and 3C illustrate a top view and two cross sectional views of another embodiment of an optical modulator constructed in accordance with the principles of the present invention;

FIGS. 4A, 4B and 4C illustrate a top view and two cross sectional views of an additional embodiment of an optical modulator constructed in accordance with the principles of the present invention;

FIGS. 5A, 5B, 5C, 6A, 6B and 6C illustrate various views of a partially completed optical modulator at selected stages in a manufacturing process, constructed in accordance with the principles of the present invention; and

FIG. 7 illustrates a diagram of an embodiment of an optical communications system that is constructed in accordance with the principles of the present invention.

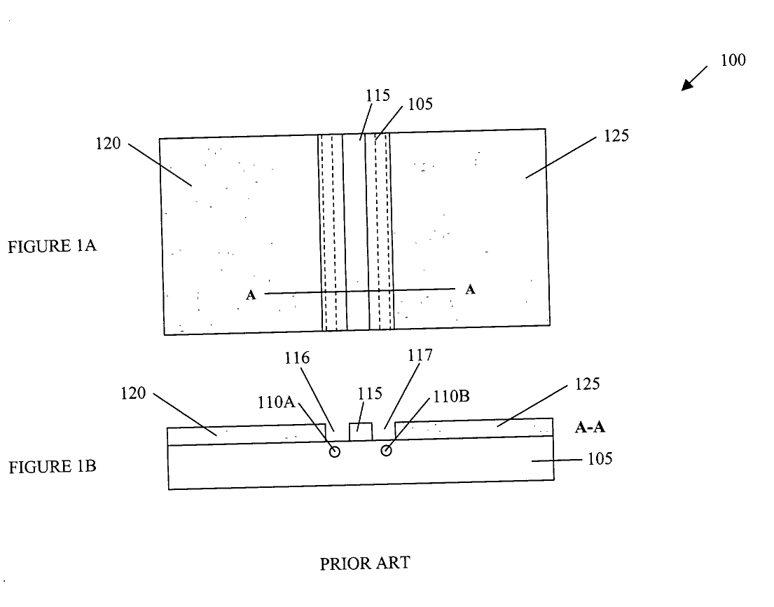

### DETAILED DESCRIPTION

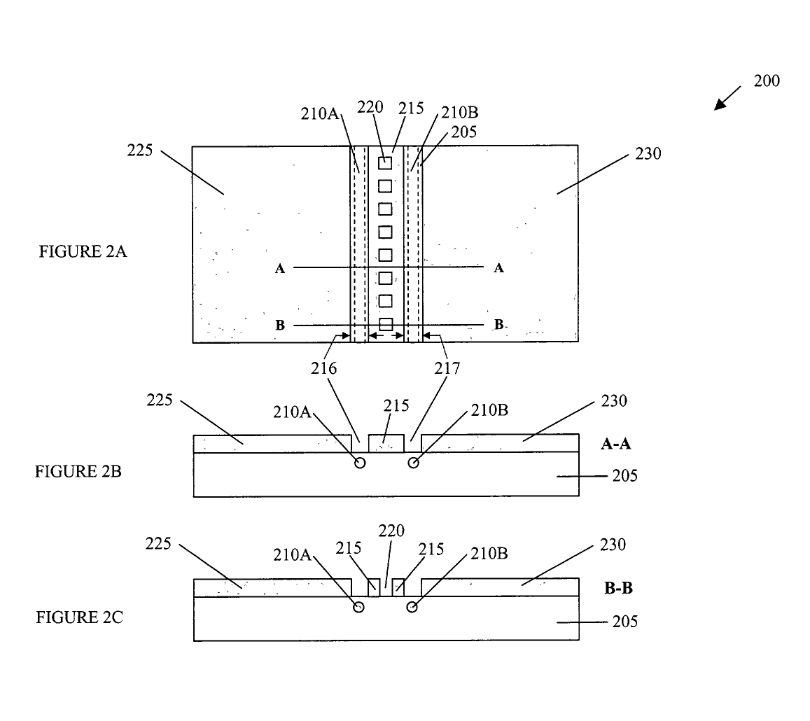

Referring initially to FIGS. 2A, 2B and 2C, illustrated are a top view and two cross sectional views of an embodiment of an optical modulator, generally designated 200, constructed in accordance with the principles of the present invention. The optical modulator 200 includes a substrate 205, an optical waveguide 210 having first and second elements 210A, 210B and a first electrode 215, located adjacent the optical waveguide 210, having a collection of apertures 220 located within the first electrode 215. The optical modulator 200 further includes second and third electrodes 225, 230 located over the substrate 205 and having separation gaps 216, 217 from the first electrode 215, respectively. In the illustrative embodiment shown, the separation gaps 216, 217 are located substantially directly over the first and second elements 210A, 210B, respectively.

As shown, the substrate 205 is an X cut lithium niobate crystal, which contains the optical waveguide 210 employed as a waveguide pair. Of course, the use of other waveguide configurations is well within the broad scope of the present invention. In the illustrative embodiment shown, the centrally positioned first electrode 215, having the collection of apertures 220 located therein, is located adjacent the optical waveguide 210 and substantially symmetric over a centerline between the first and second elements 210A, 210B. The first electrode 215 and the collection of apertures 220 constitute a symmetric ladder structure wherein the ladder structure allows the width of the first electrode 215 to better approximate an increased width of the waveguide 210.

This additional width is achieved while maintaining a characteristic impedance (approximately 50 ohms for this embodiment) of a modulating signal transmission path formed by the first, second and third electrodes 215, 225, 230. This additional width also allows a modulating signal to employ a reduced voltage (typically a 10 to 20 percent reduction for this embodiment) due to an enhanced coupling, afforded by the additional width of the first electrode 215, to the first and second elements 210A, 210B forming the waveguide pair.

As illustrated in FIG. 2A, the shape of each of the collection of apertures 220 may be square. However, other shapes are well within the broad scope of the present invention. For example, the shape of each of the collection of apertures 220 may include a rectangle, a triangle, a pentagon, a circle or an ellipse as well as any combination thereof deemed appropriate to a particular requirement. Additionally, the ladder structure may contain either more or less apertures than shown in FIG. 2, as deemed appropriate. In fact, the shape of an aperture may be of any form that allows the width of the first electrode 215 to increase to accommodate the width of the optical waveguide 210 while maintaining a desired characteristic impedance.

The transmission path employing the first, second and third electrodes 215, 225, 230 provides for a balanced operation of the optical modulator 200 employing a differential drive signal. The first electrode 215 typically serves as a common point and the second and third electrodes 225, 230 accommodate modulating signals having opposite polarities. This action induces substantially equal and opposite modulating fields along the first and second elements 210A, 210B thereby balancing the signals induced into the optical waveguide 210. Therefore, this geometry provides a modulating signal having substantially zero chirp, since the balanced drive modulating scheme produces substantially no undesired phase shift error in the waveguide pair.

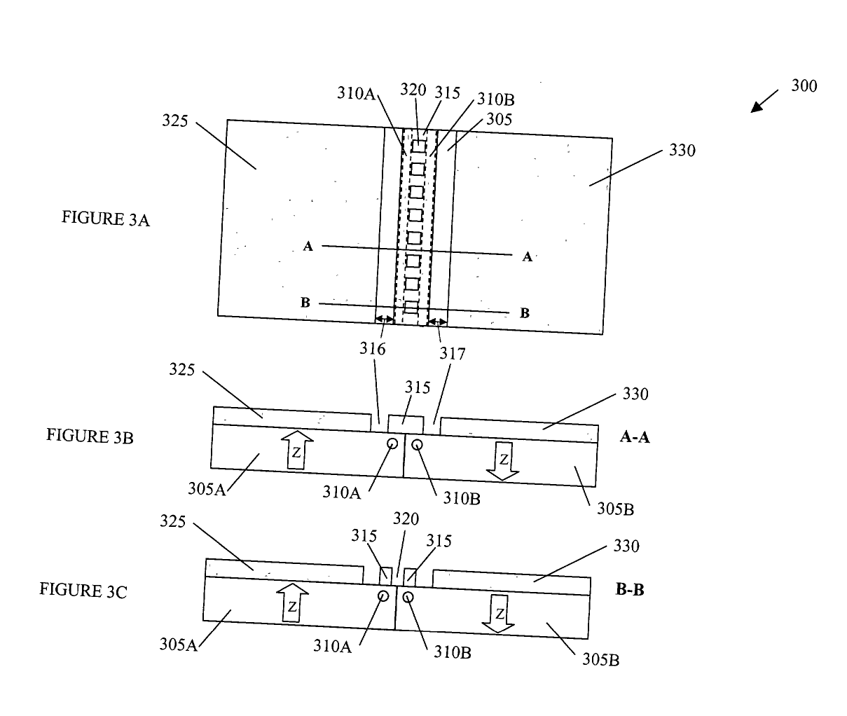

Turning now to FIGS. 3A, 3B and 3C, illustrated are a top view and two cross sectional views of another embodiment of an optical modulator, generally designated 300, constructed in accordance with the principles of the present invention. The optical modulator 300 includes substrates 305A, 305B, an optical waveguide 310 having first and second elements 310A, 310B and a first electrode 315 having a collection of apertures 320 that are located adjacent the optical waveguide 310. The optical modulator 300 further includes second and third electrodes 325, 330, respectively located over the substrates 305A, 305B, that employ respective separation gaps 316, 317 from the first electrode 315. In the illustrative embodiment shown, the separation gaps 316, 317 are located above the optical waveguide 310 but not squarely over the first and second elements 310A, 310B.

The substrates 305A, 305B, as illustrated, are Z cut lithium niobate crystals, wherein each contains one of the elements 310A, 310B that are employed as a waveguide pair. Of course, the use of other waveguide configurations is well within the broad scope of the present invention. In this embodiment, the substrate 305A employs a poling that is equal and opposite to a poling in the substrate 305B and is substantially symmetric about the centerline between the first and second elements 310A, 310B. This poling may be induced by an appropriate application of a several kilovolt potential difference across a non-poled substrate.

The first electrode 315 and the collection of apertures 320 also constitute a symmetric ladder structure wherein the ladder structure allows the width of the first electrode 315 to better approximate an enhanced width of the optical waveguide 310. This additional width is also achieved while maintaining a desired characteristic impedance associated with a modulating signal transmission path formed by the first, second and third electrodes 315, 325, 330. This additional width also allows a modulating signal to employ a reduced voltage due to an enhanced coupling, afforded by the additional width of the first electrode 315, to the waveguide 310A, 310B. This embodiment also provides for a balanced drive modulation signal operation that produces substantially zero chirp as discussed with respect to FIG. 2. Additionally, although the collection of apertures 320 is shown substantially square in shape, an aperture may be of any shape as discussed with respect to FIG. 2.

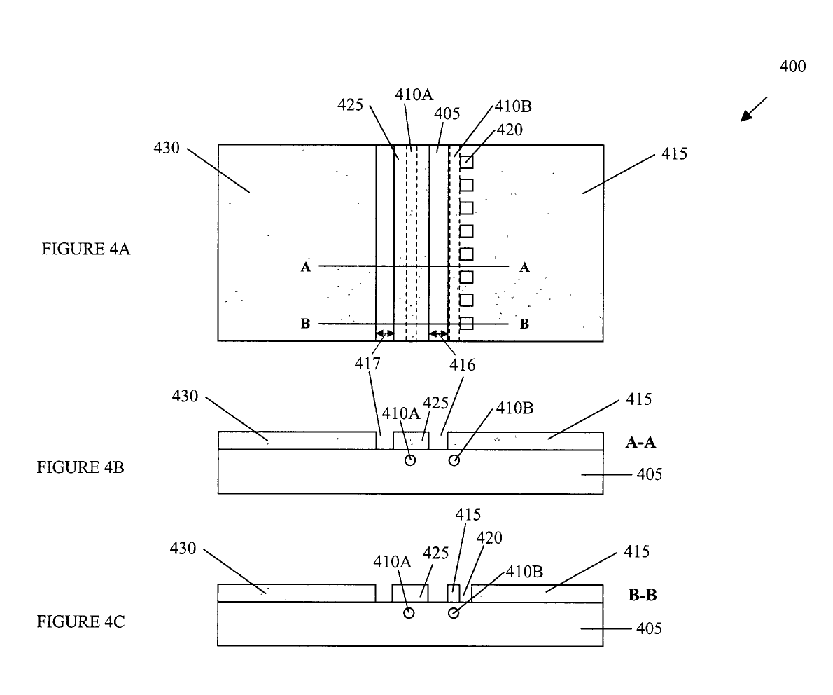

Turning now to FIGS. 4A, 4B and 4C, illustrated are a top view and two cross sectional views of an additional embodiment of an optical modulator, generally designated 400, constructed in accordance with the principles of the present invention. The optical modulator 400 includes a substrate 405, an optical waveguide 410 having first and second elements 410A, 410B and a first electrode 415 having a collection of apertures 420 and located adjacent the optical waveguide 410. The optical modulator 400 further includes second and third electrodes 425, 430 located over the substrate 405 and having first and second separation gaps 416, 417 from the first electrode 415 and the second electrode 425, respectively.

The substrate 405, in the illustrative embodiment shown, is a Z cut lithium niobate crystal, which contains the optical waveguide 410 that is also employed as a waveguide pair. Of course, the use of other waveguide configurations is well within the broad scope of the present invention. In this embodiment, the substrate 405 does not employ poling as was discussed with respect to FIG. 3 above. The first electrode 415 is an asymmetric ladder structure that is not a center electrode. The first electrode 415 is located offset from a centerline between the first and second elements 410A, 410B wherein the collection of apertures are not positioned directly over the optical waveguide 410. The second electrode 425 is located substantially symmetric over the first element 410A, and the first separation gap 416 is located over the optical waveguide 410.

The collection of apertures 420 allow an increased separation between the first and second elements 410A, 410B while maintaining a desired characteristic impedance and an enhanced modulation signal environment, as discussed above. This increased separation of the first and second elements 410A, 410B allows a beneficial reduction in noise and interference for the optical waveguide 410. The collection of apertures 420 allow an improved focusing of the modulating signal for required design constrains with respect to the optical waveguide 410 as compared to conventional electrode structures.

In the illustrated embodiment, the transmission path employing the first, second and third electrodes 415, 425, 430 provides for a modulating signal that is a single drive (i.e., a single-ended signal rather than a balanced operation employing a differential signal). This is accomplished by electrically connecting the first and third electrodes 415, 430 together as a common point for the low side of a modulating signal and applying the single-ended high side of the modulation signal to the second electrode 425.

Employing a single drive modulating signal is typically more operationally simple than employing a differential drive modulating signal. However, wherein the balanced operation modulating signal embodiments of FIGS. 2A-2C and 3A-3C generates substantially zero chirp, the single drive modulating signal of the present embodiment produces a non-zero chirp. Recall that chirp is an undesired phase shift error between the elements 410A, 410B of the waveguide pair, which in the current embodiment is generated by a modulating signal from an unsymmetrical modulating structure. However, the modulating structure consisting of the first, second and third electrodes 415, 425, 430 of the illustrated embodiment provides an improved footprint over the optical waveguide 410. Therefore, a reduced chirp of up to about 40 percent may typically be obtained over conventional structures.

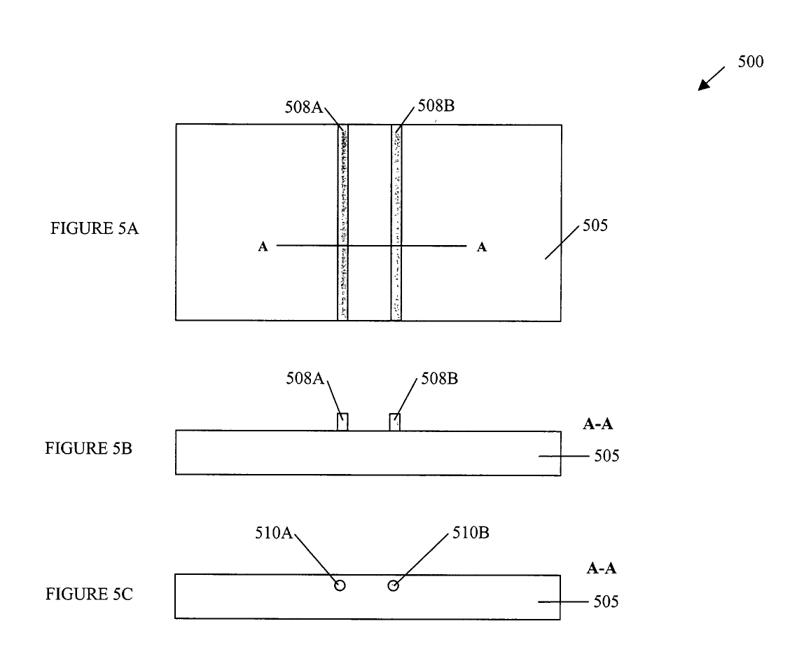

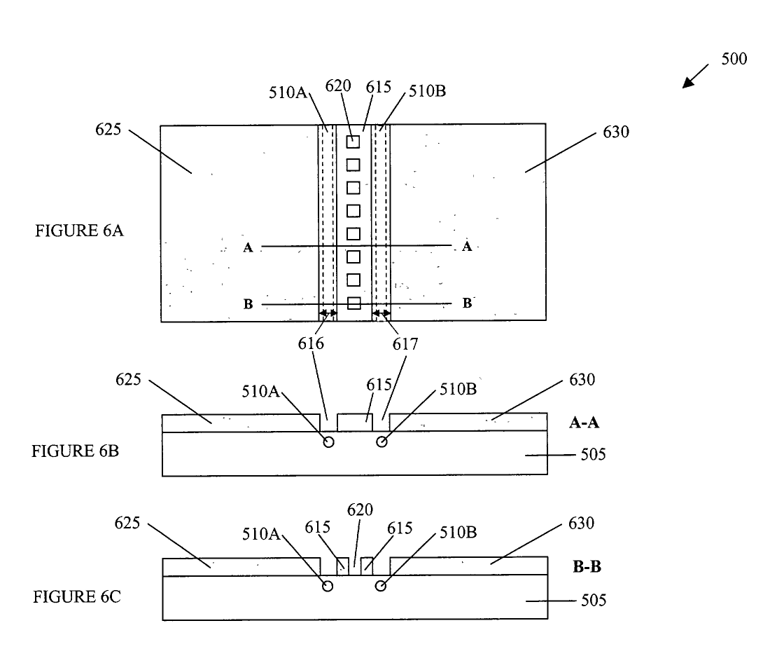

Turning now to FIGS. 5A, 5B, 5C, 6A, 6B and 6C, illustrated are various views of a partially completed optical modulator 500 at selected stages in a manufacturing process, constructed in accordance with the principles of the present invention. The manufacturing process may employ conventional procedures wherein manufacturing starts with providing a substrate 505. In FIGS. 5A-5C, the substrate 505 generally comprises an electrooptic crystal, such as lithium niobate, having an X cut or a Z cut configuration wherein an optical waveguide 510 having first and second elements 510A, 510B is constructed. Of course, other substrate materials and waveguide configurations are well within the broad scope of the present invention.

FIGS. 5A and 5B show a top view and a sectioned view of a partially completed substrate 505. Conventional patterning processes and physical vapor deposition (PVD), chemical vapor deposition (CVD) or other conventional processes, known to one of ordinary skill in the art, may be employed to form the waveguide layouts 508A, 508B using an appropriate dopant such as titanium. Thermally diffusing the waveguide layouts 508A, 508B may then be employed to form the first and second elements 510A, 510B in the substrate 505.

FIGS. 6A-6C illustrate an electrode structure that is constructed over the substrate 505. Conventional procedures and materials may be used to construct the electrode structure, which consists of first, second and third electrodes 615, 625, 630. The electrode structure may first be formed as a solid conductive layer. Then, first and second separation gaps 616, 617 may be formed by etching through the conductive layer, in the positions shown above the first and second elements 510A, 510B, to the depth of the substrate 505. A collection of apertures 620 also may be formed by etching through the conductive layer that forms the first electrode 615, in the pattern shown, to the depth of the substrate 505. Of course, other aperture patterns, as previously discussed, may be employed.

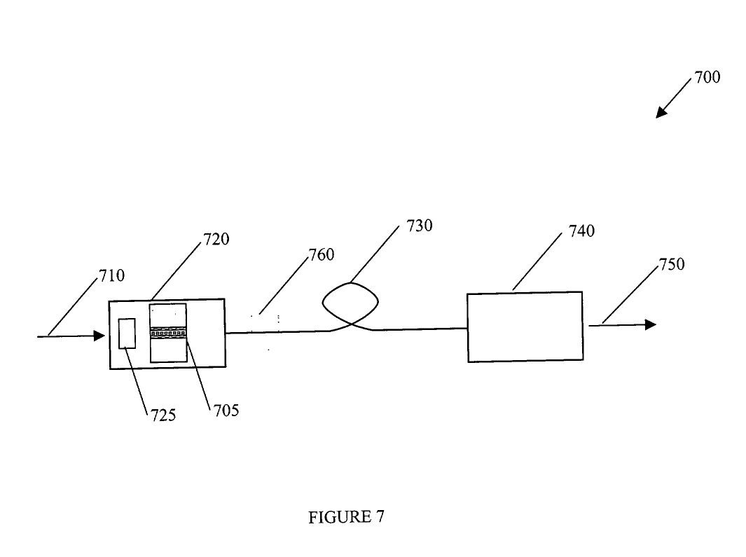

Turning now to FIG. 7, illustrated is a diagram of an optical communications system 700, which may form one environment in which an optical modulator 705, in accordance with the principles of the present invention, may be used. An initial signal 710 enters a transmitter 720 of the optical communications system 700. The transmitter 720, receives the initial signal 710, addresses the signal 710 and sends the resulting information across an optical fiber 730 to a receiver 740. The receiver 740 receives the information from the optical fiber 730, addresses the information and sends an output signal 750.

In the illustrative embodiment shown in FIG. 7, the optical modulator 705 forms a part of the transmitter 720. As illustrated, the transmitter 720 further includes a light source 725 coupled to the optical modulator 705. While the optical modulator 705 has been illustrated within the transmitter 720, one skilled in the art understands the optical modulator 705 may be included anywhere in the optical communications system 700, such as the receiver 740, or other positions as appropriate.

The optical communications system 700 is not limited to the devices previously mentioned. For example, the optical communications system 700 may include an element 760, such as a laser, diode, modulator, optical amplifier, optical waveguide, photodetectors, or other similar device.

Although the present invention has been described in detail, those skilled in the art should understand that they can make various changes, substitutions and alterations herein without departing from the spirit and scope of the invention in its broadest form.

What is claimed is:

1. An optical modulator, comprising:
a substrate having a waveguide located therein; and
an electrode located adjacent said waveguide, wherein said electrode has at least one aperture located therein.

2. The optical modulator as recited in claim 1 wherein said electrode comprises a ladder structure having at least two apertures located therein.

3. The optical modulator as recited in claim 1 wherein said aperture comprises a shape selected from the group consisting of:
a square,
a rectangle,
a triangle,
a pentagon,
a circle, and
an ellipse.

4. The optical modulator as recited in claim 1 wherein said waveguide comprises two elements operable as a waveguide pair.

5. The optical modulator as recited in claim 4 wherein said aperture is located substantially symmetric to a centerline of said waveguide pair.

6. The optical modulator as recited in claim 4 wherein said aperture is located offset from a centerline of said waveguide pair.

7. The optical modulator as recited in claim 4 wherein said modulator further includes another electrode having a gap between said electrode and said another electrode wherein said gap is located over said waveguide pair.

8. The optical modulator as recited in claim 1 wherein said lithium niobate crystal has a Z cut configuration that comprises a poling substantially symmetric about a centerline of said waveguide pair.

9. The optical modulator as recited in claim 1 wherein said electrode is a first electrode and said modulator further comprises second and third electrodes proximate said first electrode.

10. The optical modulator as recited in claim 1 wherein said optical modulator is included within an optical transmitter including a light source.

11. A method of manufacturing an optical modulator, comprising:
constructing a waveguide within a substrate; and
forming an electrode located adjacent said waveguide and having at least one aperture located therein.

12. The method as recited in claim 11 wherein said forming said electrode comprises forming a ladder electrode structure having at least two apertures located therein.

13. The method as recited in claim 11 wherein said forming said aperture comprises a shape selected from the group consisting of:
a square,
a rectangle,
a triangle,
a pentagon,
a circle, and
an ellipse.

14. The method as recited in claim 11 wherein said constructing said waveguide comprises constructing two elements operable as a waveguide pair.

15. The method as recited in claim 11 wherein forming said electrode includes forming a first electrode, and further includes forming second and third electrodes proximate said first electrode.

16. An optical transmitter, comprising:
a light source; and
an optical modulator that is coupable to said light source, including:
a substrate having a waveguide located therein; and
an electrode structure located over said waveguide having:
a first electrode that is adjacent said waveguide, and that has at least one aperture located therein, and
a second electrode that is proximate said first electrode.

17. The optical transmitter as recited in claim 16 wherein said first electrode comprises a ladder electrode structure having at least two apertures located therein.

18. The optical transmitter as recited in claim 16 wherein said aperture comprises a shape selected from the group consisting of:
a square,
a rectangle,
a triangle,
a pentagon,
a circle, and
an ellipse.

19. The optical transmitter as recited in claim 16 wherein said waveguide comprises two elements that are operable as a waveguide pair.

20. The optical transmitter as recited in claim 16 wherein said modulator further comprises a third electrode that is proximate said first and second electrodes.
